(19) United States
(12) Patent Application Publication
(10) Pub. No.: US 2013/0332335 A1
(43) Pub. Date: Dec. 12, 2013

(54) Method and System for Ordering Construction Lien and Notice Documents Over the Internet, Mobile Application or Communications Network.

(71) Applicant: Scott Gerard Wolfe, New Orleans, LA (US)

(72) Inventor: Scott Gerard Wolfe, New Orleans, LA (US)

(21) Appl. No.: 13/490,749

(22) Filed: Jun. 7, 2012

(51) Int. Cl. G06Q 40/02

(52) U.S. Cl. CPC G06Q 40/025
USPC 705/38

(57) ABSTRACT

This invention provides a method and system for ordering notice, lien and bond claim documents using internal databases and logic through the following steps: 1) The user inputs required data including State, Role, Hired-by Role, Project, and Document/Serviced Ordered; 2) The invention processes database record for product/service and creates an identifier for additional information required, including Dates, Contacts, and Extra Fields; 3) The invention requests from the user the Dates, Contacts, and Extra Fields required by the identifier created; 4) User inputs the requested information; 5) The information is transmitted to the company.

### CROSS-REFERENCE TO RELATED APPLICATIONS

This Nonprovisional Utility patent application claims the benefit of a previously filed provisional patent under 35 USC 199(e), the application number of which is 61/502,483.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

Mechanics Liens:

Those furnishing labor, materials and/or services to private, state and federal construction projects around the United States have possible “mechanic's lien” claims in the event they are unpaid for their contribution. Popularly referred to as a “mechanic's lien,” the legal remedy is also called a “claim of lien,” “materialmen's lien,” “property lien,” “contractor lien,” “construction lien,” “statement of claim and privilege,” “notice of claim of lien,” and “stop work order.” When the labor, materials or services are furnished to a construction project owned privately (non-governmental ownership), the lien is placed against the property itself. When the labor, materials or services are furnished to a state or federal construction project, a lien against the government owned property is typically not available, but instead a “lien” is made against a bond under the federal Miller Act or each individual state's “Little Miller Act.” This lien remedy, which goes by many names and has different characteristics depending on the construction project's type, is referred to herein collectively as a “mechanic's lien.”

While the ability to file a mechanic's lien is uniformly available across the United States and its territories, the laws regulating its filing differs from state-to-state. In addition to each state having unique mechanic's lien laws, within these laws different treatment is afforded to construction participants depending on their role in the project (i.e. original contractor, subcontractor, architect, supplier, equipment lessor, etc), their tier in the project (i.e. their place in the contractual chain starting from the property owner or public entity commissioning work) and the type of construction project where services are furnished (i.e. commercial, residential, owner-occupied residential, industrial, oil & gas, state, federal, etc.).

To preserve one's right to file a mechanics lien, many states require project participants to meet pre-lien statutory notice requirements. In some states, notices are required before services are provided, and in others notices are required within a certain period before the lien is filed. In other states, notices are not required at all. These notices must meet statutory requirements, and must be sent according to the state's statutory service or delivery standards.

The act of filing a mechanics lien is also subject to varied legal requirements, with each state setting forth specific elements required within a mechanic's lien. After a lien is filed, many states require the mechanic's lien be served upon certain parties through pre-defined methods.

Finally, the mechanic's lien is a temporary encumbrance on private property or a surety bond. The encumbrance lasts for a specific period of time as provided by each jurisdiction's statute, and the encumbrance expires at the end of this time period unless action is taken by the lien claimant. In some jurisdictions, the mechanic's lien claim may be “extended” through a supplemental filing. When unable to extend or further extend a lien, the mechanic's lien claim must be “foreclosed upon” by filing an action seeking foreclosure in a designated court of law.

Web Applications, Product Ordering Interfaces, Mobile Applications, Widgets, Communications Networks:

The World Wide Web (WWW) is a well-known network of computers, whereby users around the world can access information displayed within a web browser. Typically the user accesses certain web pages that are displayed to the user through the HTML (Hyper-Text Markup Language) protocol. The user calls and retrieves specific HTML pages by requesting the page through a known URL (Uniform Resource Locator) using HTTP (HyperText Transfer Protocol).

Using certain computer languages such as PHP, Javascript, and HTML, listed here illustratively only and as examples, it has become common for companies and individuals to write applications that run and operate through web browsers on the World Wide Web. These web applications are similar to software applications that are written to operate on a user's desktop, except that they run through web browsers on the web.

Typically, a user will visit a certain website and be required to login to their account. Once logged in, the user will have access to the web application and its features. A web application can be designed to appear on a web browser access via a personal computer, or on a “mobile browser,” which is a web browser optimized for viewing on a mobile device.

Although web applications viewing on a standard web browser may be viewed on a mobile device through a mobile web browser, mobile devices also have the ability to run native mobile applications. These applications are optimized to operate on a mobile device (such as an iPhone or iPad, or an Android OS device) with or without the use of an Internet connection. The user opens the application on his or her mobile device and is able to view, alter and interact with the application without the use of a browser.

Next, a Product Ordering Interface is an interface on the WWW that a user accesses through an HTTP request. Here, the user will find the ability to order certain products from the website, including, in the instance of this invention, mechanic's liens, bond claim forms, notices, lien cancellations, and similar products.

A popular Product Ordering Interface is the “shopping cart” model, whereby a purchaser selects an item from an electronic catalog, which is electronically added to the purchaser's “shopping cart”, and when the purchaser is done selecting items all the orders in the shopping cart are “checked out” when the purchaser provides its billing and/or payment information.

Another Product Ordering Interface that is also popular is the less-sophisticated form-based system, whereby the purchaser selects the product or service through an electronic catalog of services or products, and is then forwarded to an online form where information about the purchaser (including the billing and payment information) is gathered.

Finally, a “widget” is a term of art defined by Wikipedia as “a small application that can be installed and executed within a web page by an end user.” Or more further described therein as “a stand-alone application that can be embedded into third party sites by any user on a page where they have rights of authorship.” Other terms used to describe web widgets include: portlet, gadget, badge, module, webjit, capsule, snippet, mini and flake.

A widget may be installed on any web page, displaying content to the viewer, or offering a certain application or function to the viewer. When an application or function is offered, the widget runs a script stored on the originating server, such that the viewer is able to complete a function within the widget without the host-site storing the function's code and framework.

For the purposes of this Specification, all of these applications, interfaces and networks, together with other non-discussed offline software systems and electronic communications, are collectively referred to as the “System” or “Application.”

### Construction Lien and Notices Services:

Law firms, attorneys, form companies, software companies, and legal document preparation companies offer services to contractors, suppliers, architects, engineers and other construction participants that aid them with filing construction lien and notices.

Construction liens and notices are form-driven documents, meaning that when filed or delivered, they are simply forms filled-in with the applicable information. The form varies from state-to-state, and also varies depending on subject's project type, role on the project, and who the role of party who hired the subject. The differences in the forms depend on a large number of variables, which when spread across the country, creates a significant variety of form-types that can be used for all the different construction liens and notices that may be filed.

Many companies sell forms online or in paper format at retail locations, or over the Internet. The customer experience is that they search for the type of form they need (without a significant degree of help or instruction), buy the form, and fill it in with the applicable information. The forms are static, in that they are offered as packaged only.

Other companies, commonly known as legal document preparation companies or document automation companies, will collect information from the customer, and then fill-in the form for them. In the construction industry, and particularly with regard to construction liens and notices, it is also common for these companies to deliver or file the form after completion as part of the service. However, insofar as construction liens and notices are concerned, because of the large number of variables between forms as above-discussed, previous methods to collect information from the potential customer through the Product Ordering Interface has been extraordinarily inefficient. Mostly, potential customers are asked to fill-in a static web form or PDF form requesting the data that is most popularly required within the multitude of construction lien and notice forms.

Attorneys and law firms offer legal advice and the preparation of legal documents, which may include the preparation of legal forms. However, attorneys traditionally acquire the data required for each form after manually examining the client's circumstances, and then manually requesting the data required from the client.

These services and service providers are distinguished from this Invention in that, while these service providers may have use for this Invention, they do not currently have a method and system for deconstruction the complexity presented by high variability of construction lien and notice forms, and offering a simple product ordering interface to users of the System that collects information specifically applicable to the product, the subject project and the user's unique role in the subject project.

### BRIEF SUMMARY OF THE INVENTION

This invention provides a Method and System for Ordering Mechanic's Lien and Notice Documents over the internet, mobile applications, or mobile communications network utilizing database records managed by a backend Product Input System that relates products/services to states, user role, hired-by role, and project type.

### BRIEF DESCRIPTION OF THE SEVERAL VIEWS OF THE DRAWING

FIG. 1 shows the administration panel wherein an administrator can add a product to the system by inputting the required information.

FIG. 2 shows the administration panel wherein an administrator can add a date to the system by inputting the required information.

FIG. 3 shows the administration panel wherein an administrator can add a specified extra field and associated instructions to the system which can then be associated with products in the system.

FIG. 4-1 shows the user interface of the Ordering process with a sample of the information required to be provided by the user to complete ordering process.

FIG. 4-2 shows an interface in the lien management system requesting information from the user to complete ordering process.

FIG. 5 shows a visual outline of the logic used in the ordering process process, by step.

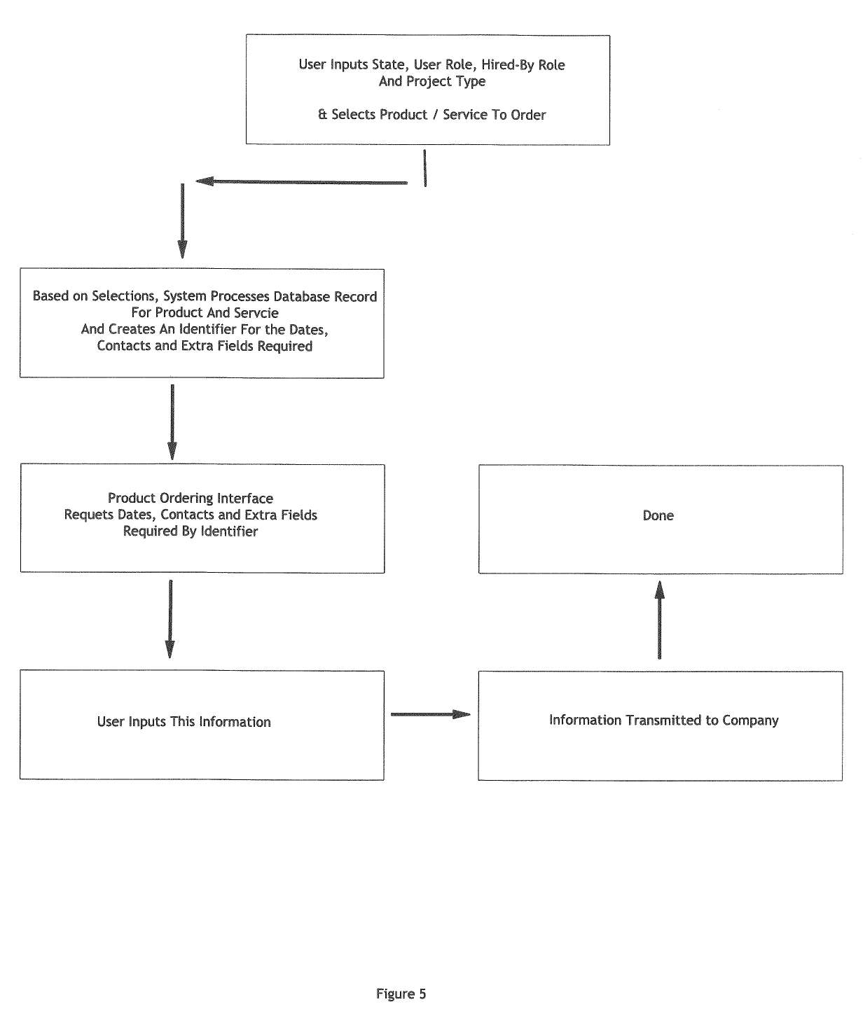

### DETAILED DESCRIPTION OF THE INVENTION

### Product Ordering Interface That Collects All Required Data

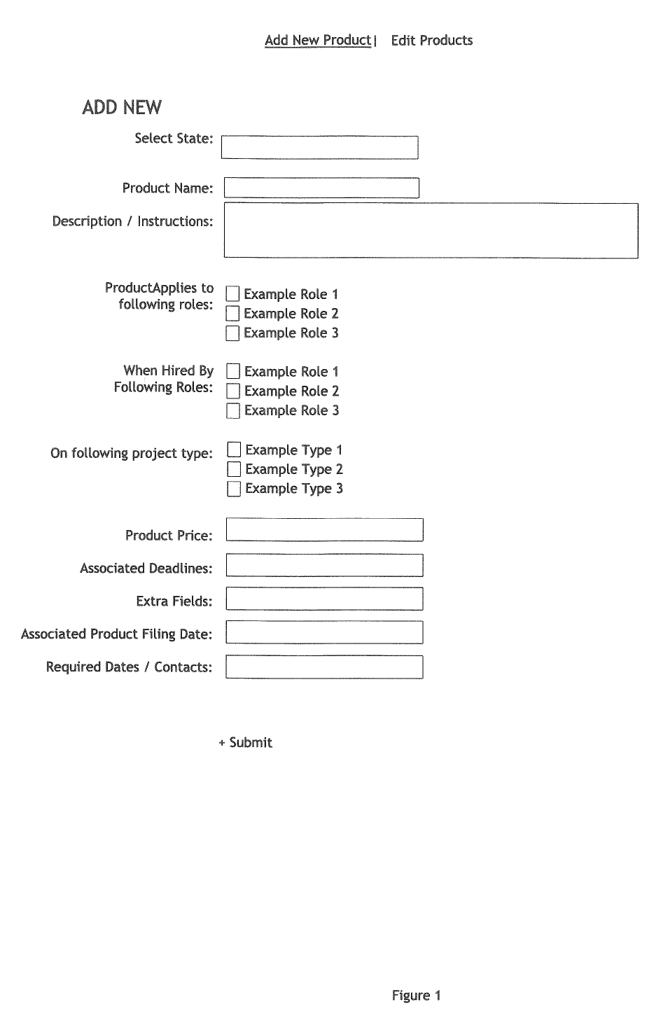

On the backend, the System has the following database structure, managed through an administration panel available to an administrator wherein s/he can add and edit applicable database records. Specifically, a backend Product Input System is built to allow administrators to create, modify and delete product/service records (FIG. 1). Products/Services are stored in the database with the following information (among other information, as only the fields relevant to this filing is noted):

### (1) Product/Service Name (Name of Product/Service)

### (2) Associated State

### (3) Product Price (Price of the Product/Service)

### (4) Associated Contractor Roles

### (5) Associated Hired By Role

### (6) Project Type

### (7) Required Dates

### (8) Required Contacts

### (9) Extra Fields

### (10) Public Instructions

First, a Product/Service record has an associated State, Contractor Role, Hired-By Role and Project Type (“state/role/type”). How these records are recorded in the database is more fully explained in Provisional Patent Application No. 61/499,609, EFS ID 10356444. The significance of associating these fields within the Product/Service record is that the System only allows users with a matching state, contractor role, hired-by role and project type to select and order the associated Product/Service.

The method and system made subject to this provisional patent application, however, benefits from these associations in that it creates a unique database record for a product or service whenever these state/role/type features exist.

So, for example, if a construction notice using one form type must be filed in California by material suppliers hired by prime contractors, and another form type must be filed by material suppliers hired by subcontractors, there would be two database records for the construction notice product, with the respective roles properly associated with each record. This works for any combination of role/type/state variations.

For the purposes of this application, this process will be referred to as the System's “Qualifying” of the Product/Service, in that the user's selection of state/role/type Qualifies certain products or services as available for purchase.

However, once the Product/Service is Qualified, there is a problem in that each of the products and services requires different information to fulfill the order for construction liens and notices. The System solves this problem with a method whereby the System processes the database records for the applicable Product/Service, and requests that the customer provide only that information required by the specific Product/Service record.

The Product/Service record knows the information relevant because of the relationship between it and tables for: (i) Date types; (ii) Contact types; and (iii) Other Extra Fields types.

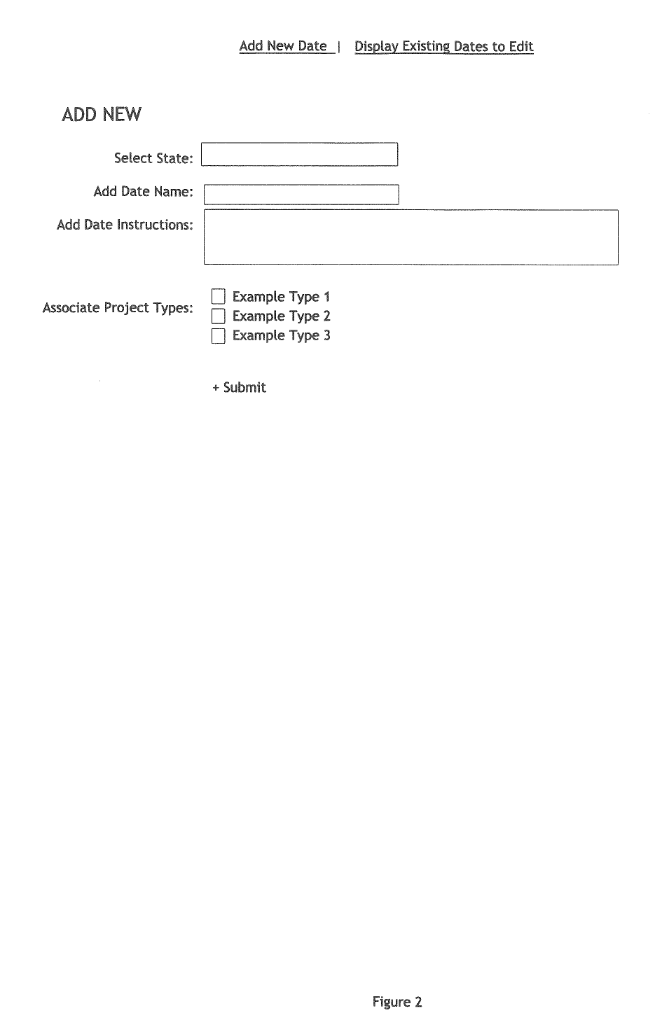

The backend Date Input System (FIG. 2) allows administrators to create, modify and delete system deadlines, dates, and products. Dates are stored in the database with the following information:

### (1) Date Name

### (2) Associated States

### (3) Associated Project Types

### (4) Date Description/Instructions

When completing the Product Input System (FIG. 1), only those Dates within the database that match the Product's State/Project Type is available for association.

The backend Contact Types Input System simply allows the administrator to identify construction participant role identifiers, and associate them with states and project types. When completing the Product Input System (FIG. 1), only those contact types within the database that match the Product's State/Project Type is available for association. When a role is associated, the user will be required to provide the contact information (including name, address and telephone number) for the selected contact role.

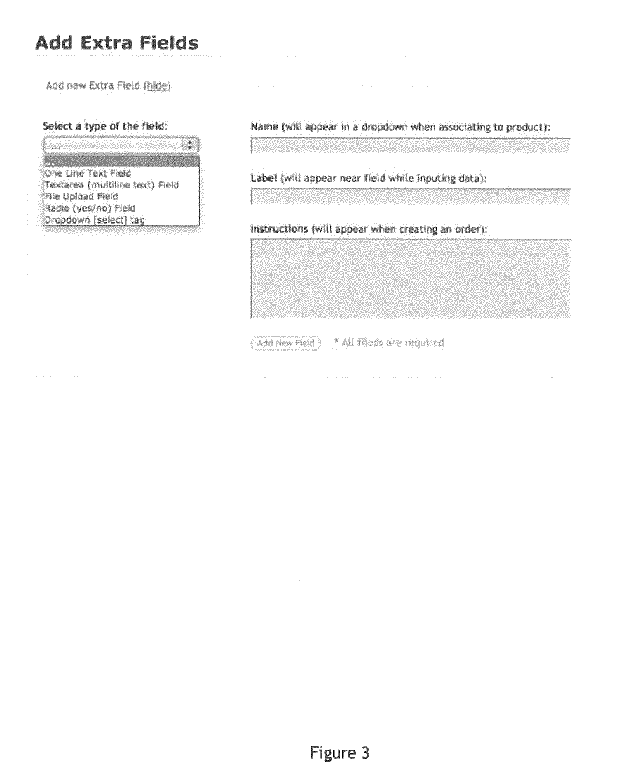

Finally, there is a back end Extra Fields Input System (FIG. 3), which allows administrators to create, modify and delete additional fields that would request additional information to complete the Product/Service order. An extra field record requires the following entry:

(1) Type of field (i.e. text, text area, file upload, yes/no, dropdown, checkbox, etc.) (2) Name of the field (3) Label of the Field (which appears in the Product Ordering Interface) (4) Instructions (which appear in the Product Ordering Interface)

When completing the Product Input System, the administrator associates extra fields with the product/service, and is given the choice of making them a required or unrequired field.

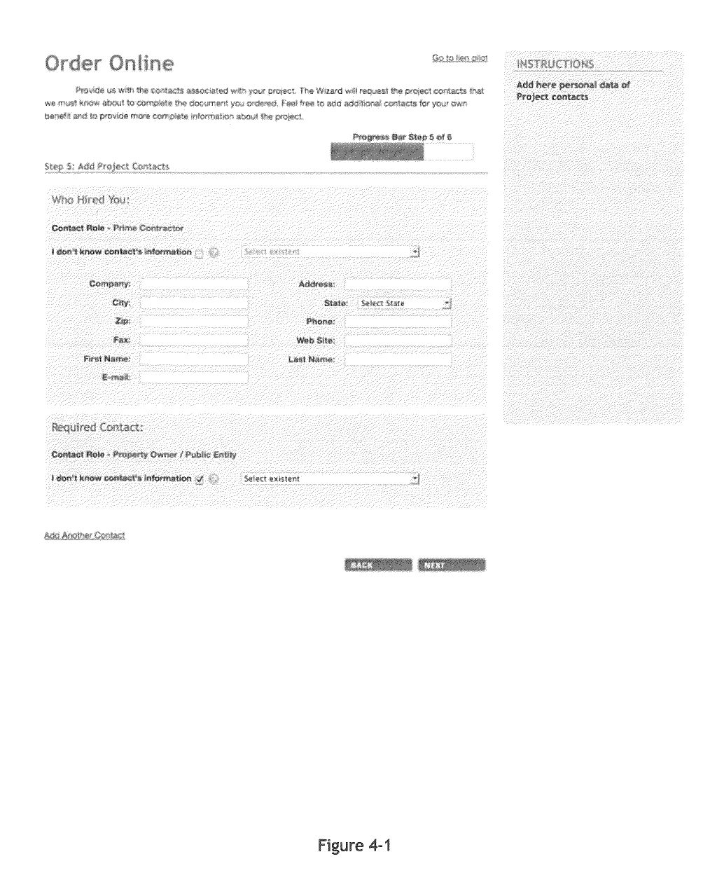

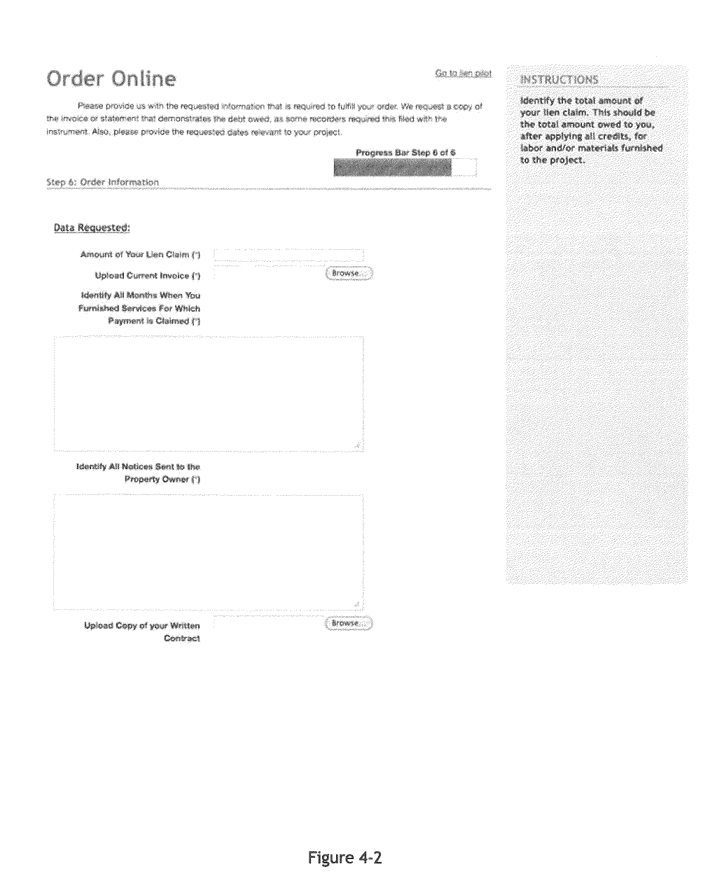

When the user is going through the Product Ordering Interface, it is then requested the data associated with the selected Product/Service (FIGS. 4-1 and 4-2). Although drawings show collection of data on two screens, Invention could also combine the two screens into one.

1) A method of making available for ordering, download, generation or other acquisition a mechanics lien, bond claim, miller act claim, lien claim, preliminary notice, notice to owner, construction notice, notice of intent to lien, pre-lien notice and related items (all hereinafter collectively referred to as “Mechanics Lien”) document(s) based upon the user of a system's specific project information, such that a user will provide:
(i) The state of the project's location;
(ii) The type of project, the available choices for this field dictated by the project's location, as described in patent application Ser. No. 13/490,645; and
(iii) The role of the user in the project, the available choices for this field dictated by the project's location and type, as described in patent application Ser. No. 13/490,645.
(iv) The role of the party who hired the user in the project, the available choices for this field dictated by the project's location and type, as described in patent application Ser. No. 13/490,645;
And thereafter, based on this information, the system will determine and display, making available for ordering, downloading, generating or acquiring, associated documents.

2) In contributing to the performance of claim Number 1, we claim a method of organizing and databasing various Mechanics Lien documents that creates an association between each specific Mechanics Lien document and the information identified in claim Number 1 as (i), (ii), (iii), and (iv), such that only the projects applicable to the identified information be made available to the system's user, except that the system can make presumptions about missing data to make available matching documents using the following logic:
(a) If a piece of data is missing from either (ii), (iii) or (iv), the system presumes that the user selects all options for the missing category(ies), and makes available all matching Mechanics Lien documents.

3) Each Mechanics Lien document requires unique data to complete or fill-in the Mechanics Lien document, and thus this application claims a method of acquiring the applicable data from a user:
(i) specific to the user's project information, gathered as elsewhere described in these claims or the claims described in patent application Ser. No. 13/490,645; and
(ii) Specific to the Mechanics Lien document selected by the system's user for ordering, downloading, generating or otherwise acquiring.

4) To facilitate the performance of the method described in claim No. 3, we claim a method of associating the data required to complete or fill-in the Mechanics Lien lien document with each document record, by:
(i) Having a database table for “date” records within the system, such that a system administrator can create different types of dates, label them, and associate them with states, project types and applicable instructions;
(ii) Having a database table for “contact” records within the system, such that a system administrator can create different types of contacts, label them, and associate them with states, product types and applicable instructions;
(iii) Having a database table for “extra fields” records within the system, such that a system administrator can create different types of extra field records, label them and associate them with applicable instructions; and
(iv) For each Mechanics Lien document record in the system database, associating the same with the date, contact and extra field records that are required to perform the method described in claim Number 3; except that
(v) Whenever a date or contact database record is not associated with a state or project type, the system will presume it is associated with the system's universe of states and product types in determining which date and contact records to allow for association with a Mechanics Lien document record.

5) A method of collecting the information required as contemplated in claims 1-4 for the ordering, generating, downloading or otherwise acquiring a Mechanics Lien document through a Product Ordering Interface.
